(19) United States
(12) Patent Application Publication
(10) Pub. No.: US 2025/0215247 A1
(43) Pub. Date: Jul. 3, 2025

(54) MULTILAYER COATING FILM

(71) Applicant: NIPPON PAINT AUTOMOTIVE COATINGS CO., LTD., Osaka (JP)

(72) Inventors: Ryoga KATAOKA, Osaka (JP); Ryohei TSUBONE, Osaka (JP); Shinichi FUJIWARA, Osaka (JP)

(73) Assignee: NIPPON PAINT AUTOMOTIVE COATINGS CO., LTD., Osaka (JP)

(21) Appl. No.: 18/956,437

(22) Filed: Nov. 22, 2024

(30) Foreign Application Priority Data
Dec. 28, 2023 (JP) 2023-223001

(51) Int. Cl. C09D 7/61; C09D 5/02; C09D 7/40; C09D 133/08

(52) U.S. Cl. CPC C09D 7/61; C09D 5/022; C09D 7/68; C09D 133/08

(57) ABSTRACT

An object of the present disclosure is to provide a multilayer coating film having a glitter texture and capable of achieving both the hiding property and the chroma of the coating film. The multilayer coating film of the present disclosure comprises an intermediate coating layer, a first base layer laminated on the intermediate coating layer, and a second base layer laminated on the first base layer, wherein a lightness L* at 45 degrees of the intermediate coating layer is 80 or more, wherein a visible light transmittance of the first base layer is 5 to 30%, wherein a visible light transmittance of the second base layer is 60% or more, and wherein the second base layer comprises a luster pigment.

### TECHNICAL FIELD

The present invention relates to a multilayer coating film.

### BACKGROUND ART

On the surface of an article to be coated such as an automobile body, a plurality of coating films (a multilayer coating film) having various roles are formed sequentially, and the article is thereby protected and concurrently provided with an aesthetic appearance and an excellent design. A common method for forming such a multilayer coating film is a method in which an undercoating film such as an electrodeposition coating film is formed on an article to be coated that has excellent conductivity, and then an intermediate coating film according is optionally formed thereon, and further a top coating film is formed. Among these coating films, the top coating films including a base coating film particularly have great influence particularly on the appearance and design of a coating film. Especially in automobiles, the appearance and design of a top coating film formed on a vehicle body are extremely important.

Base coating films can be roughly divided into coating films called solid color, being free of a scaly pigment and coating films called metallic color, containing a scaly pigment and having a glitter texture. One typical example of the scaly pigment contained in a coating film having a glitter texture is a scaly aluminum pigment. The scaly aluminum pigment can induce metallic luster (metallic feeling) in the base coating in the base coating films.

The appearance of a coating film formed on an automobile is greatly involved in an appearance value such as a luxurious feeling of the automobile. In addition, customers (consumers) who purchase automobiles tend to seek automobiles having a coating film with excellent designability. Due to such diversification and individuality of consumers' preferences, more unique designs are demanded.

Patent Document 1 describes a coating film of a coating film of a color base coating material including a coloring pigment, a coating film of a metallic base coating material having a lightness difference of 30 or less, a hue difference of 50 or less, and a chroma difference of 30 or less from the coating film of the color base coating material, and coating film structure in which a coating film of a top clear coating material are laminated.

Patent Document 2 describes a laminated coated product including a color base layer formed on a base and a mica base layer formed on the color base layer, in which the hiding film thickness of the mica base layer is larger than the coating film thickness of the mica base layer and is within 10 times the coating film thickness, and the color base layer exhibits a lightness lower than the lightness of the mica base layer by an L value of 10 to 30.

Patent Document 3 describes a method for forming a multilayer coating film in which a cationic electrodeposition coating material is applied and heated and cured, then an organic solvent type or non-aqueous dispersion type thermally curable first colored coating material containing a neutralized polyvalent carboxylic acid resin having an acid value of 5 to 100 and an amino resin as essential components and having a base hiding property, a thermally curable aqueous second colored coating material, and a thermally curable aqueous transparent coating material are applied, then the three coating films are cured simultaneously by heating, and subsequently a thermally curable transparent coating material is applied, and heated and cured.

Patent Document 4 describes a method for forming a luster multilayer coating film involving forming a luster multilayer coating film having a reddish to yellowish hue on a substrate to be coated, and describes a step of applying a color base coating material to the substrate to form a color base coating film, a step of applying a luster coating material to the color base coating film to form a luster coating film, a step of applying a top clear coating material to the luster coating film to form a top clear coating film, and a step of setting an interference color in a highlight portion of the luster coating film and a color base coating film color to same type colors having a Munsell hue in a range of 10 RP to 10 Y.

### Patent Documents

Patent Document 1: JP 2005-205262 A

Patent Document 2: JP 1-215380 A

Patent Document 3: JP 11-104550 A

Patent Document 4: JP 2006-289247 A

### SUMMARY

However, when the chroma of a coating film is increased, the hiding property will be deteriorated, and conversely, when the hiding property of a coating film is increased, the chroma will be deteriorated. In the conventionally known multilayer coating films described in Patent Document 1 to 4, both of the hiding property and the chroma of a coating film may not be sufficiently achieved in a coating film having a glitter texture.

The present disclosure is to provide a multilayer coating film having a glitter texture and capable of achieving both the hiding property and the chroma of the coating film.

The present disclosure provides the following embodiments.
<1> A multilayer coating film comprising an intermediate coating layer, a first base layer laminated on the intermediate coating layer, and a second base layer laminated on the first base layer,
   wherein a lightness L* at 45 degrees of the intermediate coating layer is 80 or more,
   wherein a visible light transmittance of the first base layer is 5 to 30%,
   wherein a visible light transmittance of the second base layer is 60% or more, and
   wherein a second base layer comprises a luster pigment.
<2> The multilayer coating film according to <1>, wherein an absolute value of a difference between a hue hl of the first base layer and a hue h2 of the multilayer coating film is 20 or less.
<3> The multilayer coating film according to <1> or <2>, wherein a chroma C1 of the first base layer is 60 or more.
<4> The multilayer coating film according to any one of <1> to <3>, wherein a chroma C2 of the multilayer coating film is 60 or more.
<5> The multilayer coating film according to any one of <1> to <4>, wherein a glitter texture Sil5 Value of the multilayer coating film is 15 or more.
<6< The multilayer coating film according to any one of <1> to <5>,
   wherein the first base layer comprises a coloring pigment, and
   wherein a content of the coloring pigment is 5 to 60 parts by mass in 100 parts by mass of the total solid content of the first base layer.
<7> The multilayer coating film according to any one of <1> to <6>,
   wherein the second base layer comprises a coloring pigment, and
   wherein a content of the coloring pigment is 2 parts by mass or less in 100 parts by mass of the total solid content of the second base layer.
<8> The multilayer coating film according to any one of <1> to <7>, wherein a content of a black pigment in the second base layer is 0 to 0.1 parts by mass in 100 parts by mass of the total solid content of the second base layer.
<9> The multilayer coating film according to any one of <1> to <8>, wherein a content of a mica pigment in the second base layer is 0.1 to 15 parts by mass in 100 parts by mass of the total solid content of the second base layer.
<10> The multilayer coating film according to any one of any one of <1> to <9>, further comprising a first clear layer between the first base layer and the second base layer.
<11> The multilayer coating film according to any one of <1> to <10>, further comprising a second clear layer laminated on the second base layer.

### EFFECTS OF THE INVENTION

The present disclosure provides a multilayer coating film having a glitter texture and capable of achieving both the hiding property and the chroma of the coating film.

### DETAILED DESCRIPTION

The multilayer coating film of the present disclosure comprises an intermediate coating layer, a first base layer laminated on the intermediate coating layer, and a second base layer laminated on the first base layer,
wherein a lightness L* at 45 degrees of the intermediate coating layer is 80 or more,
wherein a visible light transmittance of the first base layer is 5% to 30%,
wherein a visible light transmittance of the second base layer is 60% or more, and
wherein the second base layer comprises a luster pigment.

The multilayer coating film of the present disclosure exhibits a glitter texture and is capable of achieving both the hiding property and the chroma of the coating film. The present disclosure should not be construed as being limited to a particular theory, but the reason the multilayer coating film of the present disclosure can exhibit such an effect is considered as follows. In the multilayer coating film of the present disclosure, the lightness of the intermediate coating layer is 80 or more, and the influence of the undercoating layer on the appearance can be suppressed to some extent. Overlaying a first base layer having transmissibility and a second base layer being higher in transmissibility than the first base layer and comprising a luster pigment on the intermediate coating layer, a multilayer coating film having a good hiding property of the multilayer coating film and having chroma and glitter texture can be obtained.

In the present disclosure, the “intermediate coating film” may be a layer disposed below the first base layer, that is, on a side where a substrate is located.

In one embodiment, the multilayer coating film of the present disclosure can be used for automobile applications. In such an embodiment, the multilayer coating film of the present disclosure may be disposed on an undercoating layer, and the undercoating layer may be disposed on a substrate.

The substrate may be any material having at least a base layer such as a metal layer, a plastic layer, or a foam layer.

Examples of the metal to form the metal layer include iron, copper, aluminum, tin, zinc, and alloys thereof. The metal layer may be in a plate shape and may be a molded article. Specifically, examples of the molded article include bodies, parts, and the like of automobiles such as passenger cars, trucks, motorcycles, or buses.

The metal layer (preferably, on the base layer side of the metal layer) may have been subjected to chemical conversion treatment in advance with a phosphate salt, a zirconium salt, a chromate salt, or the like, and subsequently to formation of an electrodeposition coating film layer as an undercoating layer. Examples of the electrodeposition coating composition which can be used for the formation of an electrodeposition coating film layer include a cationic electrodeposition coating composition and an anionic electrodeposition coating composition.

Examples of the resin to form the plastic layer include polypropylene resin, polycarbonate resin, urethane resin, polyester resin, polystyrene resin, ABS resin, vinyl chloride resin, and polyamide resin. The plastic layer may be in a plate shape or may be a molded article. Examples of the molded article include automobile parts such as spoilers, bumpers, mirror covers, grills, or doorknobs. The plastic layer (preferably on the base layer side of the plastic layer) may have been provided with a primer layer as an undercoating layer.

### Multilayer Coating Film

The multilayer coating film of the present disclosure includes an intermediate coating layer, a first base layer laminated on the intermediate coating layer, and a second base layer laminated on the first base layer. The multilayer coating film of the present disclosure may further include a first clear layer between the first base layer and the second base layer. The multilayer coating film of the present disclosure may further include a second clear layer laminated on the second base layer.

### Intermediate Coating Layer

The intermediate coating layer may typically be a layer provided on an undercoating layer. The intermediate coating layer can protect the undercoating layer and impart chipping resistance to the multilayer coating film, for example, but the function thereof is not limited thereto.

The lightness L* at 45 degrees of the intermediate coating layer may be 80 or more, and preferably is 80 to 100. When the lightness L* at 45 degrees of the intermediate coating layer is in such a range, the lightness, the chroma and the hiding property of a resulting multilayer coating film can be improved.

In the present disclosure, the lightness L* at 45 degrees can be measured in accordance with JIS Z 8723.

The intermediate coating film is formed from an intermediate coating composition comprising an intermediate coating film-forming resin, a coloring pigment, an extender pigment, and the like. As the intermediate coating film-forming resin, the compounds to be recited as examples for the coating film-forming resin (A) to be used in the first and second base coating compositions described later can be used. As the coating film-forming resin to be used for the intermediate coating composition, a combination of an acrylic resin and/or a polyester resin with an amino resin and/or an isocyanate is suitably used from the viewpoint of various performances of the intermediate coating film.

Examples of the coloring pigment contained in the intermediate coating composition include pigments having no chroma such as carbon black or titanium dioxide, and pigments having chroma for compensating the hue of the base layers. When the intermediate coating composition contains a pigment, the content of the pigment is preferably 0.1 parts by mass or more, and preferably 50 parts by mass or less, based on 100 parts by mass of the resin solid content.

In a preferred embodiment, the content of the white coloring pigment such as titanium dioxide is preferably 20 parts by mass or more and more preferably 25 parts by mass or more based on 100 parts by mass of the resin solid content, the content of the black coloring pigment such as carbon black is preferably 0.1 parts by mass or less and more preferably 0.05 parts by mass or less based on 100 parts by mass of the resin solid content, and the content of other chromatic coloring pigments is preferably 0.2 parts by mass or less and more preferably 0.1 parts by mass or less based on 100 parts by mass of the resin solid content. When the ranges of the contents of the pigments are within such ranges, it can be easy to set the lightness of the intermediate coating layer to a desired range.

The thickness of the intermediate coating film may be, for example, preferably 3 to 50 μm, and more preferably 5 to 30 μm.

### First Base Layer

The first base layer is laminated on the intermediate coating layer. The first base layer may be laminated in direct contact with the intermediate coating layer, or may be laminated on the intermediate coating layer with interposition of another layer provided on the intermediate coating layer. The first base layer can impart color to the multilayer coating film, for example, but the function thereof is not limited thereto.

The transmittance in the visible light region of the first base layer may be 5 to 30%, and preferably 9 to 20%.

In the present disclosure, the transmittance in the visible light region means a transmittance for light having a wavelength of 400 to700 nm. The transmittance in the visible light region can be measured in accordance with JIS R 32124.

The first base layer preferably comprises a coloring pigment. Examples of such coloring pigments include organic coloring pigments such as azo chelate pigments, azomethine-azo pigments, azo lake pigments, insoluble azo pigments, condensed azo pigments, monoazo pigments, indanthrone pigments, disazo pigments, diketopyrrolopyrrole pigments, benzimidazolone pigments, phthalocyanine pigments, indigo pigments, thioindigo pigments, perinone pigments, perylene pigments, dioxane pigments, quinacridone pigments, quinophthalone pigments, isoindolinone pigments, naphthol pigments, pyrazolone pigments, anthanthrone pigments, anthraquinone pigments, anthrapyrimidine pigments, or metal complex pigments; inorganic coloring pigments such as chrome yellow, iron oxide, yellow iron oxide, transparent ion oxide, iron black, chromium oxide, iron-chromium, bismuth-manganese, bismuth vanadate, chromium oxide, molybdate orange, red iron oxide, titanium yellow, zinc flower, zinc yellow, ocher, carbon black, titanium dioxide, cobalt green, phthalocyanine green, ultramarine, cobalt blue, phthalocyanine blue, or cobalt violet; graphite pigment, and other coloring colored flat pigments.

The coloring pigment may have either a chromatic color or an achromatic color, and may have a color such as red, blue, yellow, green, purple, brown, white, black, or gray.

In the first base layer, the content of the coloring pigment may be preferably 5 to 60 parts by mass, and more preferably 10 to 50 parts by mass, based on 100 parts by mass of the total solid content of the first base layer. When the content of the coloring pigment in the first base layer is in such a range, the color stability against variation in film thickness can be improved.

In the present disclosure, the solid content represents a heating residue defined in JIS K 5601-1-2:2008, and is calculated by measuring the percentage of the mass of the residue after heating at 105° C. for 60 minutes based on the original mass.

The thickness of the first base layer is, for example, 3 μm or more, and preferably 5 μm or more, and is, for example, 50 μm or less, preferably 40 μm or less, and more preferably 30 μm or less.

The first base layer can be formed using a first base coating composition. The first base coating composition comprises a coating film-forming resin (A1) and a curing agent (B1). In one embodiment, the first base coating composition further comprises a coloring pigment (C1), and in another embodiment, the first base coating composition does not comprise the coloring pigment (C1).

### Coating Film-Forming Resin (A1)

The coating film-forming resin (A) represents a resin capable of forming a coating film by reacting with a curing agent (B1) described later, and preferably includes one or two or more resins selected from an acrylic resin, a polyol resin, a polyester resin, a polyurethane resin, an epoxy resin, a fluororesin, and a silicone resin, and more preferably includes one or two or more resins selected from an acrylic resin, a polyol resin, and a polyester resin. The coating film-forming resin (A1) preferably has a hydroxy group.

The coating film-forming resin (A1) preferably comprises an aqueous resin. The aqueous resin is a resin dispersed in an aqueous medium, and may be an emulsion or a dispersion. Examples of the aqueous resin include an aqueous acrylic resin dispersion, an aqueous polyester resin dispersion, an aqueous polyurethane resin dispersion, and an aqueous epoxy resin dispersion.

The coating film-forming resin (A1) preferably comprises an acrylic resin, and more preferably comprises an aqueous acrylic resin dispersion. The aqueous acrylic resin dispersion may be either an acrylic resin emulsion or an acrylic resin dispersion, and is preferably an acrylic resin emulsion. The acrylic resin contained in the aqueous acrylic resin dispersion may be in the form of particles in an aqueous medium.

Typically, the acrylic resin is obtained as a polymer of a monomer mixture comprising a (meth)acrylic monomer, and the aqueous acrylic resin dispersion is obtained by emulsion-polymerizing the monomer mixture. The monomer mixture preferably comprises a hydroxy group-containing monomer, and may further comprise an acid group-containing monomer and other monomers. In one embodiment, the monomer mixture preferably comprises an alkyl (meth)acrylate, a hydroxy group-containing monomer, and an acid group-containing monomer, and more preferably comprises an alkyl (meth)acrylate, a hydroxy group-containing monomer, an acid group-containing monomer, and a styrene-based monomer.

In the present disclosure, (meth)acrylic acid represents acrylic acid and methacrylic acid.

The alkyl (meth)acrylate is an alkyl (meth)acrylate having no acid group and no hydroxy group. An alkyl (meth)acrylate in the monomer mixture may favorably contribute to the main backbone structure of the acrylic resin.

Examples of the alkyl (meth)acrylate include methyl (meth)acrylate, ethyl (meth)acrylate, propyl (meth)acrylate, n-butyl (meth)acrylate, isobutyl (meth)acrylate, t-butyl (meth)acrylate, hexyl (meth)acrylate, 2-ethylhexyl (meth)acrylate, octyl (meth)acrylate, nonyl (meth)acrylate, decyl (meth)acrylate, dodecyl (meth)acrylate, and stearyl (meth)acrylate. Alkyl (meth)acrylates may be used singly, or two or more of them may be used in combination.

Examples of the hydroxy group-containing monomer include (meth)acrylic monomers having a hydroxy group, and specifically include hydroxyalkyl (meth)acrylates such as 2-hydroxyethyl (meth)acrylate, 2-hydroxypropyl (meth)acrylate, 4-hydroxybutyl (meth)acrylate, or 2-hydroxybutyl (meth)acrylate; and ε-caprolactone-modified (meth)acrylic monomers.

As an ε-caprolactone-modified (meth)acrylic monomer, a commercially available product may be used, and examples of the commercially available product include PLACCEL FA-1, PLACCEL FA-2, PLACCEL FA-3, PLACCEL FA-4, PLACCEL FA-5, PLACCEL FM-1, PLACCEL FM-2, PLACCEL FM-3, PLACCEL FM-4, and PLACCEL FM-5 (all manufactured by Daicel Corporation). Hydroxy group-containing monomers may be used singly, or two or more of them may be used in combination.

A hydroxy group-containing monomer in the monomer mixture may impart hydrophilicity to the resulting acrylic resin, and enhances curing reactivity between the acrylic resin and the curing agent (B) described later.

The acid group-containing monomer may be a (meth)acrylic monomer having an acid group, and such an acid group may be a carboxyl group, a sulfonic acid group or a phosphoric acid group. From the viewpoint of improvement in dispersion stability and the function of accelerating a curing reaction, the acid group is preferably a carboxyl group. An acid group-containing monomer in the monomer mixture may improve various stabilities, such as storage stability, mechanical stability, or stability against freezing, of the resulting acrylic resin, and promotes a curing reaction between an acrylic resin and a curing agent (B) at the time of coating film formation.

Examples of the acid group-containing monomer include carboxyl group-containing monomers such as (meth)acrylic acid, crotonic acid, isocrotonic acid, ethacrylic acid, propylacrylic acid, isopropylacrylic acid, itaconic acid, maleic anhydride, or fumaric acid; sulfonic acid group-containing monomers such as p-vinylbenzenesulfonic acid, p-acrylamidopropanesulfonic acid, or t-butylacrylamidosulfonic acid; and phosphoric acid group-containing monomers such as phosphate monoesters of 2-hydroxyethyl (meth)acrylate or phosphate monoesters of 2-hydroxypropyl (meth)acrylate. Acid group-containing monomers may be used singly, or two or more of them may be used in combination.

Examples of the other monomers include at least one monomer selected from the group consisting of styrene-based monomers, (meth) acrylonitrile, and (meth) acrylamide. Examples of the styrene-based monomers include styrene and α-methylstyrene. Such other monomers may be used singly, or two or more of them may be in combination.

The monomer mixture may further comprise a crosslinkable monomer such as a carbonyl group-containing monomer, a hydrolyzable silyl group-containing monomer, or various polyfunctional vinyl monomers. A crosslinkable monomer in the monomer mixture may impart self-crosslinkability to the resulting acrylic resin. Crosslinkable monomers may be used singly, or two or more of them may be used in combination.

Examples of the carbonyl group-containing monomer include monomers containing a keto group such as acrolein, diacetone (meth)acrylamide, acetoacetoxyethyl (meth)acrylate, formylstyrol, or alkyl vinyl ketones having 4 to 7 carbon atoms (for example, methyl vinyl ketone, ethyl vinyl ketone, and butyl vinyl ketone).

Examples of the hydrolyzable silyl group-containing monomer include 3-(meth)acryloxypropyltrimethoxysilane, 3-(meth)acryloxypropylmethyldimethoxysilane, and 3-(meth)acryloxypropyltriethoxysilane.

The polyfunctional vinyl monomer is a compound having two or more radically polymerizable, ethylenically unsaturated groups in the molecule. Examples of the polyfunctional vinyl monomer include polyfunctional vinyl compounds such as divinylbenzene, ethylene glycol di(meth)acrylate, hexanediol di(meth)acrylate, polyethylene glycol di(meth)acrylate, allyl (meth)acrylate, 1,4-butanediol di(meth)acrylate, 1,6-hexane di(meth)acrylate, neopentylglycol di(meth)acrylate, and pentaerythritol di(meth)acrylate, and polyfunctional monomers such as triallyl cyanurate, pentaerythritol tri(meth)acrylate, trimethylolpropane tri(meth)acrylate, and dipentaerythritol hexa(meth)acrylate.

Crosslinkable monomers may be used singly, or two or more of them may be used in combination. Examples of preferable crosslinkable monomers include allyl (meth)acrylate, ethylene glycol di(meth)acrylate, and divinylbenzene. Such crosslinkable monomers offers an advantage that the average particle size of the acrylic resin contained in the aqueous acrylic resin dispersion can be suitably controlled to 100 nm or less.

The amount of the crosslinkable monomer is preferably 0.2 to 20% by mass based on the total amount of the monomer mixture, and more preferably 0.5 to 20% by mass. The crosslinkable monomer in the monomer mixture within the above range offers an advantage that the average particle size of the acrylic resin contained in the aqueous acrylic resin dispersion to be prepared can be suitably controlled to 100 nm or less.

In the coating film-forming resin (A1), the acrylic resin contained in the aqueous acrylic resin dispersion may be in the form of particles, and the average particle size of the particles is preferably 0.01 to 1.0 μm.

In the present disclosure, the average particle size is a volume average particle size determined by a dynamic light scattering method, and specifically, it can be measured using an electrophoretic light scattering photometer ELSZ Series (manufactured by Otsuka Electronics Co., Ltd.) or the like.

In the coating film-forming resin (A1), the acrylic resin contained in the aqueous acrylic resin dispersion may be core-shell type particles.

In the coating film-forming resin (A1), the acid value of the acrylic resin contained in the aqueous acrylic resin dispersion is preferably 1 to 80 mg KOH/g, more preferably 2 to70 mg KOH/g, and still more preferably 3 to 60 mg KOH/g.

In the coating film-forming resin (A1), the hydroxyl value of the acrylic resin contained in the aqueous acrylic resin dispersion is preferably 30 to 120 mg KOH/g, and more preferably 35 to 100 mg KOH/g. Within the above range, a curing reaction advantageously proceeds to a sufficient degree and a resulting coating film exhibits favorable hardness.

In the present disclosure, the acid value and the hydroxyl value are both values expressed in terms of solid content, and are measured by the methods in accordance with JIS K 0070.

In the coating film-forming resin (A1), the weight average molecular weight of the acrylic resin contained in the aqueous acrylic resin dispersion is preferably 50,000 to 5,000,000, and more preferably 50,000 to 1,000,000. Within the above range, a resulting coating film can have various favorable performances such as hardness, adhesion, and water resistance.

In the present disclosure, the weight average molecular weight is a value obtained by converting the measurement result of gel permeation chromatography (GPC) using a polystyrene standard.

Among the solid components of the coating film-forming resin (A1), the content of the solid components of the aqueous acrylic resin dispersion is preferably 30 to 90% by mass, more preferably 40 to 85% by mass, and still more preferably 50 to 80% by mass. Within the above range, a curing reaction advantageously proceeds to a sufficient degree and a resulting coating film exhibits favorable hardness.

The aqueous acrylic resin dispersion can be produced by performing emulsion polymerization of the monomer mixture in an aqueous medium in the presence of a radical polymerization initiator and an emulsifier by heating with stirring. The reaction temperature may be, for example, about 30 to 100° C. The reaction time may be appropriately chosen according to the reaction scale and the reaction temperature, and may be, for example, about 1 to 10 hours. In the emulsion polymerization, for example, the monomer mixture or a monomer pre-emulsion liquid may be added all at once to a reaction vessel charged with water and the emulsifier, or may be dropped for a while. By appropriately selecting such a procedure, the reaction temperature can be adjusted. The monomer pre-emulsion liquid can be prepared by emulsifying the monomer mixture with at least a part of water and an emulsifier.

As the radical polymerization initiator, known initiators used in emulsion polymerization of an acrylic resin can be used. The radical polymerization initiator is preferably a water-soluble radical polymerization initiators and, for example, a persulfate such as potassium persulfate, sodium persulfate, or ammonium persulfate can be used in the form of an aqueous solution. In addition, a so-called redox initiator containing a combination of an oxidizing agent such as potassium persulfate, sodium persulfate, ammonium persulfate, or hydrogen peroxide and a reducing agent such as sodium bisulfite, sodium thiosulfate, Rongalite, or ascorbic acid can be used in the state of an aqueous solution.

Radical polymerization initiators may be used singly, or two or more of them may be used in combination.

As the emulsifier, an anionic or nonionic emulsifier selected from micelle compounds each having a hydrocarbon group having 6 or more carbon atoms and a hydrophilic moiety such as a carboxylate, a sulfonate or a sulfate partial ester in one molecule can be used. Examples of the anionic emulsifier include an alkali metal salt or an ammonium salt of a half ester of sulfuric acid with an alkyl phenol or a fatty alcohol; an alkali metal salt or an ammonium salt of an alkyl sulfonate or an allyl sulfonate; an alkali metal salt or an ammonium salt of a half ester of sulfuric acid with a polyoxyethylene alkylphenyl ether, a polyoxyethylene alkyl ether or a polyoxyethylene allyl ether. Examples of the nonionic emulsifier include a polyoxyethylene alkylphenyl ether, a polyoxyethylene alkyl ether, or a polyoxyethylene allyl ether. Other examples of the emulsifier include various anionic or nonionic, reactive emulsifiers each having, in the molecule, a radically polymerizable unsaturated double bond-containing group such as a (meth)acrylic group, a propenyl group, an allyl group, an allyl ether group, or a maleic group.

As the emulsifier, a commercially available product may be used. Examples of the commercially available product include Antox MS-60 (manufactured by Nippon Nyukazai Co., Ltd.), Eleminol JS-2 (manufactured by Sanyo Chemical Industries, Ltd.), ADEKA REASOAP SR-10 (manufactured by ADEKA Corporation), and Aqualon HS-10 (manufactured by DKS Co. Ltd.).

Emulsifiers may be used singly, or two or more of them may be used in combination.

In the emulsion polymerization, an auxiliary agent for controlling the molecular weight (chain transfer agent), such as mercaptan compounds or lower alcohols, may be used, if necessary. Such an auxiliary agent, may favorably promote emulsion polymerization, followed by the smooth and uniform formation of a coating film and the adhesion of a coating film to an article to be coated can be improved.

Any polymerization method may be appropriately adopted as the emulsion polymerization, such as a single-stage continuous uniform dropwise monomer addition method, a core-shell polymerization method that is a multi-stage monomer feeding method, and a power feed polymerization method wherein the constitution of monomers to be fed is continuously altered during polymerization.

At least a part of the acid groups contained in the acrylic resin may be neutralized by adding a neutralizing agent to the aqueous acrylic resin dispersion obtained. The neutralization can improve the stability of the aqueous acrylic resin dispersion. Examples of the neutralizing agent include basic compounds. Examples of the basic compounds include ammonia; organic amines such as monomethylamine, dimethylamine, trimethylamine, triethylamine, diisopropylamine, monoethanolamine, diethanolamine, or dimethylethanolamine (dimethylaminoethanol), and inorganic bases such as sodium hydroxide, potassium hydroxide, or lithium hydroxide. Neutralizing agents may be used singly, or two or more of them may be used in combination.

The polyol resin is a resin having two or more hydroxy groups in the molecule, and examples thereof include polyether polyol and polycarbonate polyol. As the polyol resin, a polyether polyol such as polypropylene glycol is preferable.

In the first base coating composition, the content of the solid components of the polyol resin may be preferably 1 to 70 parts by mass, more preferably 5 to 50 parts by mass, and still more preferably 10 to 30 parts by mass, based on 100 parts by mass of the total amount of the solid components of the aqueous acrylic resin dispersion.

The aqueous polyester resin dispersion can be prepared, for example, by condensing a polyhydric alcohol component and a polybasic acid component, and then dispersing the resulting condensate in water with a basic compound. The aqueous polyurethane resin dispersion can be prepared, for example, by polymerizing a polyol compound, a compound having an active hydrogen group and a hydrophilic group in the molecule, an organic polyisocyanate by using, as necessary, a chain extender and a polymerization terminator, and then dispersing the resulting polymer in water.

In the first base coating composition, the content of the solid components in the aqueous polyester resin dispersion may be preferably 10 to 90 parts by mass, more preferably 20 to 80 parts by mass, and still more preferably 30 to 70 parts by mass, based on 100 parts by mass of the total amount of the solid components of the aqueous acrylic resin dispersion.

The hydroxyl value of the coating film-forming resin (A1) is preferably 30 to 120 mg KOH/g, and more preferably 35 to 100 mg KOH/g. Within the above range, a curing reaction sufficiently proceeds and a resulting coating film exhibits favorable hardness.

The content of the solid components of the coating film-forming resin (A1) may be preferably 10 to 90% by mass, more preferably 15 to 85% by mass, and still more preferably 20 to 80% by mass, based on 100% by mass of the solid content of the first base coating composition.

### Curing Agent (B1)

The curing agent (B1) may be a compound having, in one molecule, two or more groups capable of reacting with the coating film-forming resin (A1), and corresponds to a coating film-forming component together with the coating film-forming resin (A1). As the curing agent (B1), one or more member selected from an amino resin (melamine resin, urea resin, benzoguanamine resin, or the like), a blocked isocyanate compound, an epoxy compound, an aziridine compound, a carbodiimide compound, an oxazoline compound, and a metal ion may be used.

In one embodiment, the curing agent (B1) preferably comprises an amino resin, and more preferably comprises a melamine resin. A coating film can be formed through a reaction of amino groups in the melamine resin with hydroxy groups contained in the coating film-forming resin (A1) along with self-polymerization of the melamine resin and.

The melamine resin is obtained by modifying a condensate of an amino compound, such as melamine, and an aldehyde compound, such as formaldehyde or acetaldehyde, with a lower alcohol, such as methanol, ethanol, propanol, or butanol. The melamine resin is preferably a compound having three reactive functional groups represented by the following formula as reactive functional groups in one molecule of triazine nucleus, or a polycondensate thereof,

−NX¹X²
wherein X¹ and X² each independently represent a hydrogen atom, a methylol group, or —CH₂—OR¹;
R¹ represents an alkyl group having 1 to 8 carbon atoms, preferably a linear or branched alkyl group having 1 to 8 carbon atoms; and
when a plurality of —CH₂—OR¹ is included in the same molecule, a plurality of R¹s may be the same or different.

Examples of the melamine resin include the following four types: a full alkyl type containing only —N(CH₂OR¹)₂ as reactive functional; a methylol group type containing —N—(CH₂OR¹)(CH₂OH) as a reactive functional group; an imino group type containing —N—(CH₂OR¹)(H) as a reactive functional group; and a methylol/imino group type containing —N(CH₂OR¹)(CH₂OH) and —N(CH₂OR¹)(H) or containing —N(CH₂OH)(H) as reactive functional groups. In the full alkyl type, methylol group type, imino group type, or methylol/imino group type melamine resin, R¹ is preferably an alkyl group having 1 to 4 carbon atoms, and is preferably a methyl group, an n-butyl group, or an isobutyl group. In one embodiment, a methyl group and a butyl group may be mixed, in another embodiment, R¹ may be only a methyl group, and in still another embodiment, R¹ may be only a butyl group.

As the melamine resin, a commercially available product may be used. Examples of the commercially available product include a methylol group-imino type methyl/butyl mixed etherified melamine resin such as CYMEL 202; imino-type methyl/butyl mixed etherified melamine resins such as CYMEL 204, CYMEL 211, CYMEL 250, CYMEL 254, MYCOAT 212, MYCOAT 518, and MYCOAT 525; full alkyl type methylated melamine resins such as CYMEL 350; imino group type methylated melamine resins such as CYMEL 325, CYMEL 327, CYMEL 385, CYMEL 701, CYMEL 712, MYCOAT 723, and MYCOAT 776; imino group type butylated melamine resins such as MYCOAT 508; methylol group type methylated melamine resins such as CYMEL 370; and methylol group type methyl/isobutyl mixed etherified melamine resins such as MYCOAT 2677 (all manufactured by Allnex Japan Inc.).

The solid content of the melamine resin may be 0% by mass, and is preferably 80 to 100% by mass, more preferably 90 to 100% by mass, and still more preferably 95 to 100% by mass in 100% by mass of the total solid content of the curing agent (B1).

The content of the melamine resin may be 0 parts by mass, or may be preferably 10 to 90 parts by mass, or 20 to 80 parts by mass, in 100 parts by mass of the sum total of the solid content of the coating film-forming resin (A1) and the solid content of the curing agent (B1). In this range, a resulting coating film can have various favorable properties such as hardness, adhesion, and water resistance.

The blocked isocyanate compound can be prepared by adding a blocking agent having an active hydrogen to polyisocyanate such as trimethylene diisocyanate, hexamethylene diisocyanate, xylylene diisocyanate, or isophorone diisocyanate. Such a blocked isocyanate resin, upon heating, dissociates a blocking agent and generates an isocyanate group and this group reacts with a functional group in a resin component to cure the resin.

The solid content of the curing agent (B1) in the first base coating composition is preferably 20 to 50% by mass, and more preferably 20 to 40% by mass, in 100% by mass of the sum total of the solid content of the coating film-forming resin (A1) and the solid content of the curing agent (B1).

### Coloring Pigment (C1)

The coloring pigment is not particularly limited, and examples thereof include organic coloring pigments such as azo chelate pigments, azomethine-azo pigments, azo lake pigments, insoluble azo pigments, condensed azo pigments, monoazo pigments, indanthrone pigments, disazo pigments, diketopyrrolopyrrole pigments, benzimidazolone pigments, phthalocyanine pigments, indigo pigments, thioindigo pigments, perinone pigments, perylene pigments, dioxane pigments, quinacridone pigments, quinophthalone pigments, isoindolinone pigments, naphthol pigments, pyrazolone pigments, anthanthrone pigments, anthraquinone pigments, anthrapyrimidine pigments, or metal complex pigments; inorganic coloring pigments such as chrome yellow, iron oxide, yellow iron oxide, transparent ion oxide, iron black, chromium oxide, iron-chromium, bismuth-manganese, bismuth vanadate, chromium oxide, molybdate orange, red iron oxide, titanium yellow, zinc flower, zinc yellow, ocher, carbon black, titanium dioxide, cobalt green, phthalocyanine green, ultramarine, cobalt blue, phthalocyanine blue, or cobalt violet; graphite pigment, and other coloring colored flat pigments.

The coloring pigment may have either a chromatic color or an achromatic color, and may have a color such as red, blue, yellow, green, purple, brown, white, black, or gray.

The coloring pigment (C1) is preferably a coloring pigment from the viewpoint of improving weatherability and securing hiding property. In particular, titanium dioxide is more preferable because of its superiority in hiding property of color and its inexpensiveness. The pigment may be a standard gray coating composition comprising carbon black and titanium dioxide as main pigments. In addition, a coating composition may be used in which a coating composition matched with the second base coating composition in lightness, hue, or the like is combined with various coloring pigments. The first base coating composition of the present disclosure can act as a primer in applying the second base coating composition, and when containing a coloring pigment, can also act as a color base.

In the first base coating composition, the pigment mass concentration of the pigment (the ratio of the mass of the pigment to the total solid content of the first base coating composition (PWC)) is preferably 5 to 60% by mass. Setting the PWC to 5% by mass makes it easier to enhance the hiding property. Setting the PWC to 60% by mass or less makes it easier to control an increase in viscosity during curing, and therefore it becomes easier to secure flowability and obtain a good coating film appearance.

### Luster Pigment

The first base coating composition may further comprise a luster pigment. In one embodiment, the first base coating composition comprises a luster pigment, and in another embodiment, the first base coating composition does not comprise a luster pigment.

Examples of the luster pigment include metallic luster pigments such as aluminum, copper, zinc, iron, nickel, tin, aluminum oxide, and their alloys; mica pigments such as interference mica pigments and white mica pigments; graphite pigments, and glass flake pigments.

The average particle size of the luster pigment may be preferably 1 to 30 μm, and more preferably 5 to 25 μm. The average thickness of the luster pigment may be preferably 0.01 to 6 μm, and more preferably 0.1 to 5 μm.

In the present disclosure, the average particle size of the luster pigment means an average major axis. The average particle size can be measured by observing the luster pigment using a shape analysis laser microscope (for example, VK-X 250 manufactured by KEYENCE CORPORATION), and determining the number average value of the maximum lengths (major axes) of arbitrarily selected 100 pigments.

In the present disclosure, the average thickness t of the luster pigment can be calculated by the following formula on the basis of the water surface diffusion area (WCA: m²/g) per gram of the luster pigment.

t(μm)=0.4/[WCA (m²/g)]

In the present disclosure, the water surface diffusion area can be measured in accordance with JIS K 5906.

The water surface diffusion area (WCA) of the luster pigment may be preferably 0.06 to 40 m²/g, and more preferably 0.08 to 4 m²/g. When the water surface diffusion area of the luster pigment is within the above range, an appearance with high graininess is afforded by a resulting coating film.

When the luster pigment is an aluminum pigment, this may have been subjected to surface treatment, as necessary. Examples of the surface treatment that can be applied to the aluminum pigment include a surface treatment using a metal oxide-based compound, a surface treatment using a phosphorus compound, a surface treatment using an amine compound, and a surface treatment using a silane compound.

Examples of the metal oxide-based compound include metal oxides containing at least a transition metal element as a constituent metal, alkali metal salts thereof, and ammonium salts thereof. Examples thereof specifically include molybdenum trioxide, molybdic acid, alkali metal molybdates, ammonium molybdate, vanadic acid, alkali metal vanadates, and ammonium vanadate. The alkali metal is not particularly limited, and examples thereof include sodium and potassium. Among them, as the metal oxide-based compound, one or two or more metal oxide-based compounds selected from the group consisting of molybdic acid, an alkali metal molybdate, an ammonium molybdate, vanadic acid, an alkali metal vanadate, and an ammonium vanadate are preferably used.

Examples of the phosphorus compound include organic phosphoric acid esters, organic phosphorous acid esters, organic phosphonic acids, and amine salts of these compounds. These phosphorus compounds may be used singly, or two or more of them may be used in combination.

Examples of the amine compound include a linear or branched primary amine, a linear or branched secondary amine, a linear or branched tertiary amine, an alicyclic primary amine, an alicyclic secondary amine, an alicyclic tertiary amine, an aromatic group-containing primary amine, an aromatic group-containing secondary amine, and an aromatic group-containing tertiary amine. These amine compounds may have a substituent (for example, a hydroxy group), as necessary. The amine compounds may be used singly, or two or more of them may be used in combination.

Examples of the silane compound include alkoxysilane compounds, vinyl group-containing silane coupling agents, epoxy group-containing silane coupling agents, styryl group-containing silane coupling agents, (meth)acrylic group-containing silane coupling agents, amino group-containing silane coupling agents, isocyanate group-containing silane coupling agents, ureido group-containing silane coupling agents, mercapto group-containing silane coupling agents, acid anhydride group-containing silane coupling agents, and partial condensates thereof. These silane compounds may be used singly, or two or more of them may be used in combination.

The surface treatment can be performed under treatment conditions usually used by those skilled in the art. As to the surface treatment, a single type of surface treatment may be carried out, or two or more types of surface treatment may be used in combination.

As the luster pigment, a commercially available product may be used. Examples of the commercially available product include ALPASTE 93-0647, 06-0672, TCR-2020, and MG1000 (all manufactured by Toyo Aluminium K.K.), and ALUMINIUM PASTE MH-9901 and the like (manufactured by Asahi Kasei Corporation).

In one embodiment, the content of the luster pigment may be preferably 1 to 45 parts by mass, and more preferably 2 to 35 parts by mass, based on 100 parts by mass of the resin solid content of the coating film-forming resin (A1). The pigment mass concentration of the luster pigment in the first base coating composition may be preferably 2 to 40% by mass, more preferably 2.5 to 35% by mass, and still more preferably 3 to 30% by mass.

The first base coating composition may not comprise a luster pigment, and in another embodiment, the pigment mass concentration of the luster pigment in the first base coating composition may be 0% by mass.

The coloring pigment (C1) and the luster pigment may be used in the preparation of the first base coating composition in the form of a pigment dispersion paste prepared in advance. The pigment dispersion paste is obtained by dispersing a pigment, a pigment dispersant, and a part of the coating film-forming resin (A1) to be used as necessary in a small amount of an aqueous medium in advance. The pigment dispersant may be a resin having a structure containing a pigment-affinitive part and a hydrophilic part. Examples of the pigment-affinitive part and the hydrophilic part include nonionic, cationic, and anionic functional groups. The pigment dispersant may have two or more types of the above-mentioned functional groups in one molecule.

Examples of the nonionic functional group include a hydroxy group, an amide group, and a polyoxyalkylene group. Examples of the cationic functional group include an amino group, an imino group, and a hydrazino group. Examples of the anionic functional group include a carboxyl group, a sulfone group, and a phosphoric acid group. Such pigment dispersants can be produced by methods well known to those skilled in the art.

The pigment dispersant is not particularly limited as long as it does not contain any volatile basic substance in its solid content or contains a volatile basic substance in a content of 3% by mass or less, preferred is a pigment dispersant capable of dispersing a pigment efficiently by a small amount of the pigment dispersant. As the pigment dispersant, a commercially available product may be used. Examples of the commercially available product include Disperbyk-180, Disperbyk-190 (both manufactured by BYK-Chemie GmbH), EFKAPOLYMER 4550 (manufactured by BASF), and EFKAPOLYMER 4585 (manufactured by BASF), which are anion-nonionic dispersants, Solsperse 27000 (manufactured by Avecia), which is a nonionic dispersant, Solsperse 41000 and Solsperse 53095 (both manufactured by Avecia), which are anionic dispersants, and Disperbyk-2015 as a copolymer (manufactured by BYK-Chemie GmbH).

The weight average molecular weight of the pigment dispersant is preferably 1,000 to 100,000, more preferably 2,000 to 100,000, and still more preferably 4,000 to 50,000.

The pigment dispersion paste can be prepared by mixing and dispersing a pigment dispersant, a pigment, and a part of a coating film-forming resin (A1) to be used as necessary in accordance with a known method. The proportion of the pigment dispersant during the production of the pigment dispersion paste is preferably 1 to 50% by mass, based on the solid content of the pigment dispersion paste. When the proportion of the pigment dispersant is within the above range, pigment dispersion stability and the physical properties of a resulting coating film can be held in favorable ranges. The proportion of the pigment dispersant is more preferably 3% by mass or more, and more preferably 5% by mass or less.

The first base coating composition of the present disclosure preferably comprises an aqueous medium. The aqueous medium in the present disclosure may be water; hydrophilic solvent; or a mixture of water and a hydrophilic solvent. Examples of the hydrophilic solvent include glycol-based solvents such as ethylene glycol, propylene glycol, butanediol, diethylene glycol, dipropylene glycol, and triethylene glycol; glycol ether-based solvents such as ethylene glycol monobutyl ether (butyl cellosolve), diethylene glycol monobutyl ether, triethylene glycol monoethyl ether, propylene glycol monomethyl ether, propylene glycol monoethyl ether, propylene glycol monopropyl ether, dipropylene glycol monomethyl ether, and dipropylene glycol monoethyl ether; alcohol-based solvents such as methanol, ethanol, isopropyl alcohol, and benzyl alcohol; cyclic ether-based solvents such as dioxane and tetrahydrofuran; ketone-based solvents such as acetone; and N-methyl-2-pyrrolidone.

### Other Components

The first base coating composition may comprise, in addition to the components described above, an additive commonly used by those skilled in the art as long as this does not affect coating film performance and coating film appearance. Examples of the additives include pigments such as an extender pigment, a coloring pigment, and a rust preventive pigment; an anti-sagging and anti-settling agent; a curing catalyst (organometallic catalyst); a color separation inhibitor; a dispersant; an antifoaming/anti-bubbling agent; a surface conditioning agent; a viscosity modifier; a viscosity control agent; a leveling agent; a matting agent; an antioxidant; an ultraviolet ray inhibitor; a plasticizer; a film formation aid; an antifoaming agent; and a phosphate group-containing organic compound.

Examples of the extender pigment include titanium oxide, calcium carbonate, barium sulfate, barium carbonate, magnesium silicate, clay, talc, silica, and calcined kaolin.

### Viscosity Modifier

The first base coating composition of the present disclosure preferably comprises a viscosity modifier. When the first base coating composition comprises the viscosity modifier, thixotropy is imparted to the first base coating composition, coating workability is improved, and the appearance of a resulting multilayer coating film can be improved.

Viscosity modifiers include organic viscosity modifiers and inorganic viscosity modifiers. Examples of the organic viscosity modifiers include crosslinked or non-crosslinked resin particles; polyamide-based viscosity modifiers such as a swelling dispersion of an aliphatic acid amide, amide-based fatty acids, and phosphate salts of long-chain polyaminoamides; and polyethylene-based viscosity modifiers such as a colloidal swelling dispersion of polyethylene oxide. Examples of the inorganic viscosity modifiers include organic bentonite-based viscosity modifiers such as organic acid smectite clay and montmorillonite.

Examples of the viscosity control agent include a nonionic associated urethane viscosity control agent, an alkali-swollen viscosity control agent, and bentonite, which is an inorganic intercalation compound.

In the first base coating composition, the solid concentration (the total content of solid components) is 15 to 40% by mass, preferably 18 to 35% by mass, and more preferably 20 to 30% by mass.

The first base coating composition can be produced by a method usually used by those skilled in the art, such as kneading and dispersing a coating film-forming resin (A1) and a curing agent (B1), and a coloring pigment (C1), a luster pigment, other components, additives, and so on to be used as necessary by use of a disperser, a homogenizer, a kneader, or the like.

In the above production method, it is preferable, for example, to prepare in advance a paste comprising the coloring pigment (C1) or the luster pigment and a pigment dispersant to be used as necessary, and then mix the paste with other ingredients. As the pigment dispersant, the commercially available pigment dispersant described above or the like can be used.

### First Clear Layer

The first clear layer may be preferably disposed between the first base layer and the second base layer. The first clear layer may smoothen the irregularities or the like caused by a first base coating film, protect the first base coating film, and provide an aesthetic appearance. In one embodiment, the multilayer coating film of the present disclosure comprises a first clear layer, and in another embodiment, the multilayer coating film of the present disclosure comprises no first clear layer.

The thickness of the first clear layer may be preferably 15 to 40 μm, and more preferably 20 to 30 μm.

The first clear layer can be formed of a first clear coating composition. As the first clear coating composition, a clear coating composition comprising a coating film-forming resin, a curing agent, and the like can be used. Further, the clear coating composition may further comprise a coloring component as long as the design property of a base is not impaired. In addition, the clear coating composition may comprise a matting agent to afford a coating film having a desired gloss (gloss value; for example, from full gloss to full matte). Examples of the form of the clear coating composition include solvent type, aqueous type, and powder type.

From the viewpoint of transparency or resistance to acid etching, preferable examples of the solvent-type clear coating composition include a combination of an acrylic resin and/or a polyester resin with an amino resin and/or an isocyanate, or an acrylic resin and/or a polyester resin with a carboxylic acid/epoxy curing system.

Examples of the aqueous-type clear coating composition include a composition containing the coating film-forming resin contained in a coating material described above as an example of the solvent-type clear coating material, the coating film-forming resin having been hydrophilized by being neutralized with a base. The neutralization may be carried out, before or after polymerization, by adding a tertiary amine such as dimethylethanolamine or triethylamine.

The powder-type clear coating composition can be obtained using a common powder coating material such as a thermoplastic or thermally curable powder coating material. A thermally curable powder coating material is preferable because a coating film having good physical properties can be obtained therefrom. Examples of the thermally curable powder coating material specifically include epoxy-based, acrylic-based and polyester-based powder clear coating compositions, and acrylic-based powder clear coating compositions, which have good weatherability, are particularly preferable.

The first clear coating composition preferably comprises a viscosity controlling agent added to ensure coating workability. As the viscosity controlling agent, one that exhibits a thixotropic property can be commonly used. For example, as such a material, ones conventionally known can be used. The first clear coating composition may comprise a curing catalyst, a surface conditioning agent, and so on, as necessary.

### Second Base Layer

The second base layer is laminated on the first base layer. The second base layer may be laminated in direct contact with the first base layer, or may be laminated on the first base layer with interposition of another layer provided on the first base layer, for example, the first clear layer. The second base layer can impart glitter texture to the multilayer coating film, for example, but the function thereof is not limited thereto.

The transmittance in the visible light region of the second base layer is 60% or more, and may be preferably 65 to 100%, more preferably 70 to 100%, and still more preferably 75 to 100%.

The second base layer comprises a luster pigment (C2). Examples of the luster pigment include metallic luster pigments such as aluminum, copper, zinc, iron, nickel, tin, aluminum oxide, and their alloys; mica pigments such as interference mica pigments and white mica pigments; graphite pigments, and glass flake pigments. The second base layer preferably comprises a mica pigment from the viewpoint of imparting transparency to a resulting multilayer coating film.

In the luster pigment (C2), the content of the mica pigment may be preferably 80 to 100% by mass, more preferably 90 to 100% by mass, and still more preferably 95 to 100% by mass, in 100% by mass of the total solid content of the luster pigment (C2).

The average particle size of the luster pigment (C2) may be preferably 1 to 30 μm, and more preferably 5 to 25 μm. The average thickness of the luster pigment (C1) may be preferably 0.01 to 6 μm, and more preferably 0.1 to 5 μm.

When the luster pigment (C2) is an aluminum pigment, this may have been subjected to surface treatment, as necessary. Examples of the surface treatment that can be applied to the aluminum pigment include a surface treatment using a metal oxide-based compound, a surface treatment using a phosphorus compound, a surface treatment using an amine compound, and a surface treatment using a silane compound. As the metal oxide-based compound, the phosphorus compound, the amine compound, and the silane compound, the same compounds as the compounds recited as examples in the description of the luster pigment to be used for the first base coating composition can be used. The surface treatment can be performed under treatment conditions usually used by those skilled in the art. As to the surface treatment, a single type of surface treatment may be carried out, or two or more types of surface treatment may be used in combination.

As the luster pigment, a commercially available product may be used. Examples of the commercially available product include ALPASTE 93-0647, 06-0672, TCR-2020, and MG1000 (all manufactured by Toyo Aluminium K.K.), and ALUMINIUM PASTE MH-9901 and the like (manufactured by Asahi Kasei Corporation).

In the second base layer, the content of the luster pigment (C2) may be preferably 0.1 to 15 parts by mass, more preferably 0.5 to 10 parts by mass, and still more preferably 1 to 5 parts by mass, in 100 parts by mass of the solid content of the second base layer.

In the second base layer, the content of the mica pigment may be preferably 0.1 to 15 parts by mass, more preferably 0.5 s to 10 parts by mass, and still more preferably 1 to 5 parts by mass, in 100 parts by mass of the solid content of the second base layer.

The second base layer may comprise a coloring pigment. As the coloring pigment, any of pigments, the same pigments described as examples of the coloring pigment that may be included in the first base layer can be used.

In the second base layer, the content of the coloring pigment may be preferably 2 parts by mass or less, more preferably 0.001 to 1 part by mass, and still more preferably 0.01 to 0.1 parts by mass, based on 100 parts by mass of the total solid content of the second base layer. When the content of the coloring pigment in the second base layer is in such a range, transparency and hue variability can be improved.

In the second base layer, the content of a black pigment is preferably small. For example, in the second base layer, the content of the black pigment may be preferably 0 to 0.1 parts by mass, more preferably 0 to 0.05 parts by mass, and still more preferably 0 to 0.001 parts by mass, based on 100 parts by mass of the total solid content of the second base layer. When the content of the black pigment is in such a range, it is easy to enhance the transparency of a resulting multilayer coating film.

The thickness of the second base layer is, for example, 0.1 μm or more, preferably 3 μm or more, and more preferably 5 μm or more, and is, for example, 50 μm or less, preferably 30 μm or less, and more preferably 20 μm or less.

The second base layer can be formed using a second base coating composition. The second base coating composition comprises a coating film-forming resin (A2) and a curing agent (B2). In one embodiment, the second base coating composition further comprises a luster pigment (C2), and in such an embodiment, the second base coating composition may or may not further comprise a coloring pigment. In another embodiment, the second base coating composition comprises no luster pigment (C2), and in such an embodiment, the second base coating composition may or may not further comprise a coloring pigment.

### Coating Film-Forming Resin (A2)

The coating film-forming resin (A2) is a resin capable of forming a coating film through reacting with a curing agent (B2) described later, and any of the resins described as the coating film-forming resin (A1) can be used. The resin composition of the coating film-forming resin (A1) and the resin composition of the coating film-forming resin (A2) may be either the same or different.

The coating film-forming resin (A2) preferably comprises an acrylic resin, and more preferably comprises an aqueous acrylic resin dispersion. When both the coating film-forming resin (A1) and the coating film-forming resin (A2) comprise an acrylic resin, or when the coating film-forming resin (A2) comprises an acrylic resin, the storage stability of the resulting coating composition and various physical properties such as water resistance or weather resistance of a resulting coating film can be improved. In addition, adhesion between the first base coating film and the second base coating film can be improved. As the acrylic resin and the aqueous acrylic resin dispersion, any of the resins and any of the aqueous dispersions described as the acrylic resin and the aqueous acrylic resin dispersion in the coating film-forming resin (A1) can be used, and the acrylic resin and the aqueous dispersion can be produced by the same method.

In the coating film-forming resin (A2), the acrylic resin contained in the aqueous acrylic resin dispersion may be in the form of particles, and the average particle size of the particles is preferably 0.01 to 1.0 μm.

In the coating film-forming resin (A2), the acrylic resin contained in the aqueous acrylic resin dispersion may be core-shell type particles.

In the coating film-forming resin (A2), the acid value of the acrylic resin contained in the aqueous acrylic resin dispersion is preferably 1 to 80 mg KOH/g, more preferably 2 to 70 mg KOH/g, and still more preferably 3 to 60 mg KOH/g.

In the coating film-forming resin (A2), the hydroxyl value of the acrylic resin contained in the aqueous acrylic resin dispersion is preferably 30 to 120 mg KOH/g, and more preferably 35 to 100 mg KOH/g. Within the above range, a curing reaction sufficiently proceeds and a resulting coating film exhibits favorable hardness.

The weight average molecular weight of the acrylic resin contained in the aqueous acrylic resin dispersion in the coating film-forming resin (A2) is 50,000 to 5,000,000, and more preferably 50,000 to 1,000,000. Within the above range, a resulting coating film may have various favorable performances such as hardness, adhesion, or water resistance.

Among the solid components of the coating film-forming resin (A2), the content of the solid components of the aqueous acrylic resin dispersion is preferably 20 to 90% by mass, more preferably 25 to 85% by mass, and still more preferably 30 to 80% by mass. Within the above range, a curing reaction sufficiently proceeds and a resulting coating film exhibits favorable hardness.

In the second base coating composition, the content of the solid components of the polyol resin may be preferably 1 to 90 parts by mass, more preferably 10 to 70 parts by mass, and still more preferably 30 to 50 parts by mass, based on 100 parts by mass of the total amount of the solid components of the aqueous acrylic resin dispersion.

In the second base coating composition, the content of the solid components in the aqueous polyester resin dispersion may be preferably 20 to 80 parts by mass, more preferably 30 to70 parts by mass, and still more preferably 40 to 65 parts by mass, based on 100 parts by mass of the total amount of the solid components of the aqueous acrylic resin dispersion.

The coating film-forming resin (A2) preferably has a hydroxy group. The hydroxyl value of the coating film-forming resin (A2) is preferably 30 to 120 mg KOH/g, and more preferably 35 to 100 mg KOH/g. Within the above range, a curing reaction sufficiently proceeds and a resulting coating film exhibits favorable hardness.

The content of the solid components of the coating film-forming resin (A2) may be preferably 10 to 90% by mass, more preferably 15 to 85% by mass, and still more preferably 20 to 80% by mass, based on 100% by mass of the solid content of the second base coating composition.

### Curing Agent (B2)

The curing agent (B2) may be a compound having, in one molecule, two or more groups capable of reacting with the coating film-forming resin (A2), and corresponds to a coating film-forming component together with the coating film-forming resin (A2). As the curing agent (B2), any of the compounds described as the curing agent (B1) can be used. The curing agent (B1) and the curing agent (B2) may be either the same or different.

In one embodiment, the curing agent (B2) preferably comprises an amino resin, and more preferably comprises a melamine resin. A coating film can be formed through a reaction of amino groups contained in the melamine resin with hydroxy groups contained in the coating film-forming resin (A2) along with self-polymerization of the melamine resin.

The solid content of the melamine resin may be 0% by mass, and is preferably 80 to 100% by mass, more preferably 90 to 100% by mass, and still more preferably 95 to 100% by mass in 100% by mass of the total solid content of the curing agent (B2).

The content of the melamine resin may be 0 parts by mass, or may be preferably 10 to 80 parts by mass, or 20 to 70 parts by mass, in 100 parts by mass of the sum total of the solid content of the coating film-forming resin (A2) and the solid content of the curing agent (B2). In this range, a resulting coating film may have various favorable properties such as hardness, adhesion, and water resistance.

The solid content of the curing agent (B2) in the second base coating composition is preferably 20 to 50% by mass, and more preferably 20 to 40% by mass, in 100% by mass of the sum total of the solid content of the coating film-forming resin (A2) and the solid content of the curing agent (B2).

### Luster Pigment (C2)

The luster pigment (C2) is the same as the luster pigment (C2) that can be contained in the second base layer.

The second base coating composition of the present disclosure comprises an aqueous medium. Such an aqueous medium is the same as the aqueous medium that may be comprised in the first base coating composition.

### Other Components

The second base coating composition may comprise, in addition to the components described above, additives commonly used by those skilled in the art as long as they do not affect coating film performance and coating film appearance. As the additive, for example, one or more of the additives to be used in the first base coating composition may be appropriately comprised.

### Viscosity Modifier

The second base coating composition of the present disclosure preferably comprises a viscosity modifier. The viscosity modifier may appropriately comprise one or more among the viscosity modifiers to be used as the first base coating composition.

The second base layer preferably comprises a coloring pigment. As the coloring pigment, for example, one or more of the coloring pigments to be used in the first base coating composition may be appropriately comprised.

As the extender pigment, for example, one or more of the extender pigments to be used in the first base coating composition may be appropriately comprised.

The pigment is preferably a coloring pigment from the viewpoint of improving weatherability and securing hiding property. In particular, titanium dioxide is more preferable because it is superior in hiding property of color and is inexpensive. The pigment may be a standard gray coating composition comprising carbon black and titanium dioxide as main pigments. In addition, it is also possible to use a coating composition in which a coating composition matched with the second base coating composition in lightness, hue, or the like is combined with various coloring pigments. The first base coating composition of the present disclosure can act as a primer in applying the second base coating composition, and when containing a coloring pigment, can also act as a color base.

The luster pigment (C2) and the coloring pigment may be used in the preparation of the second base coating composition in the form of a pigment dispersion paste prepared in advance. The pigment dispersion paste is obtained by dispersing a pigment, a pigment dispersant, and a part of a coating film-forming resin (A2) to be used as necessary in a small amount of an aqueous medium in advance. As such a pigment dispersant, any of the compounds and materials described as the pigment dispersant that can be used for the first base coating composition may be used.

Examples of the viscosity control agent include a nonionic associated urethane viscosity control agent, an alkali-swollen viscosity control agent, and bentonite, which is an inorganic intercalation compound.

In the second base coating composition, the solid concentration is 15 to 40% by mass, preferably 18 to 35% by mass, and more preferably 20 to 30% by mass.

The second base coating composition can be produced by a method usually used by those skilled in the art, such as kneading and dispersing a coating film-forming resin (A2) and a curing agent (B2), and a luster pigment (C2), other components, additives, and so on to be used as necessary by use of a disperser, a homogenizer, a kneader, or the like.

In the above production method, it is preferable, for example, to prepare in advance a paste comprising the luster pigment (C2) and a pigment dispersant to be used as necessary, and then mix the paste with other ingredients. As the pigment dispersant, the commercially available pigment dispersant described above or the like can be used.

### Second Clear Layer

The second clear layer may be preferably laminated on the second base layer. The second clear layer may smoothen the irregularities or the like caused by a second base coating film, protect the second base coating film, and provide with an aesthetic appearance. In one embodiment, the multilayer coating film of the present disclosure comprises the second clear layer.

The thickness of the second clear layer may be 10 to 80 μm, and preferably 20 to 60 μm. When the thickness of the second clear layer is in such a range, irregularities can be sufficiently hidden, and defects such as bubbles or sagging during application can be suppressed.

The second clear layer can be formed from a second clear coating composition. As the second clear coating composition, a clear coating composition comprising a coating film-forming resin, a curing agent, and the like can be used. Further, the clear coating composition may further comprise a coloring component as long as the design property of a base is not impaired. In addition, the clear coating composition may comprise a matting agent to afford a coating film having a desired gloss (gloss value; for example, from full gloss to full matte). Examples of the form of the clear coating composition include solvent type, aqueous type, and powder type.

From the viewpoint of transparency or resistance to acid etching, preferable examples of the solvent-type clear coating composition include a combination of an acrylic resin and/or a polyester resin with an amino resin and/or an isocyanate, or an acrylic resin and/or a polyester resin with a carboxylic acid/epoxy curing system.

Examples of the aqueous-type clear coating composition include a composition containing the coating film-forming resin contained in a coating material disclosed above as an example of the solvent-type clear coating material, the coating film-forming resin having been hydrophilized by being neutralized with a base. The neutralization may be carried out, before or after polymerization, by adding a tertiary amine such as dimethylethanolamine or triethylamine.

The powder-type clear coating composition can be obtained using a common powder coating material such as a thermoplastic or thermally curable powder coating material. A thermally curable powder coating material is preferable because a coating film having good physical properties can be obtained therefrom. Examples of the thermally curable powder coating material specifically include epoxy-based, acrylic-based and polyester-based powder clear coating compositions, and acrylic-based powder clear coating compositions, which have good weatherability, are particularly preferable.

The second clear coating composition preferably comprises a viscosity controlling agent added to ensure coating workability. As the viscosity controlling agent, one that exhibits a thixotropic property can be commonly used. For example, as such a material, one conventionally known can be used. The first clear coating composition may comprise a curing catalyst, a surface conditioning agent, and so on, as necessary.

The absolute value |h2−h1| of the difference between the hue hl of the first base layer and the hue h2 of the multilayer coating film is preferably 20 or less, more preferably 0 to 5, and still more preferably 0 to 3. When the absolute value of the hue difference is within such a range, it is easy to obtain a desired hue, and coating workability can be improved.

In the present disclosure, the hue is a parameter in the L*C*H* color system, and can be measured in accordance with JIS Z 8729. The hue hl of the first base layer may be measured in a state where the first base layer is formed on the intermediate coating layer before the second base layer is formed.

The chroma C1 of the first base layer may be preferably 30 or more, more preferably 45 to 100, and still more preferably 60 to 100. When the chroma of the first base layer is in such a range, the chroma of the resulting multilayer coating film can be enhanced.

The chroma C1 of the multilayer coating film may be preferably 30 or more, more preferably 45 to 100, and still more preferably 60 to 100.

In the present disclosure, the chroma can be measured in accordance with JIS Z8729 as with the hue.

The glitter texture Si15 value of the multilayer coating film can be preferably 15 or more.

### Method for Producing Multilayer Coating Film

The method for producing a multilayer coating film of the present disclosure comprises:
a step of applying an intermediate coating composition to an article to be coated to form an intermediate coating layer;
a first base coating film forming step of applying a first base coating composition to the intermediate coating layer to form a first base coating film;
a second base coating film forming step of applying a second base coating composition to the first base coating film to form a second base coating film; and
a heating and curing step of heating and curing at least the first base coating film and the second base coating film to form a multilayer coating film.

The intermediate coating layer can be formed typically by applying the intermediate coating composition to form an intermediate coating film, and heating and curing the intermediate coating film. The heating temperature and time in the case of heating and curing the intermediate coating film can be appropriately chosen according to the composition (aqueous or solvent-type) of the coating composition and the type of the article to be coated. The heating temperature can be appropriately chosen, for example, in the range of 80 to 180° C., preferably in the range of 100 to 160° C. The heating time can be appropriately chosen, for example, in the range of 5 minutes to 60 minutes, preferably 10 minutes to 30 minutes.

The temperature at the time of preheating the intermediate coating film may be, for example, 30 to 80° C., and the preheating time may be, for example, 1 to 60 minutes.

As the article to be coated, various substrates such as a metal shaped article, a plastic shaped article, or a foamed article can be used. The base coating compositions of the present invention can be suitably used in the coating of automobile exterior panels such as automobile bodies and automobile parts. Examples of the metal molded article include plates and molded articles of iron, copper, aluminum, tin, zinc and the like, and alloys containing these metals. The examples of the metal molded article specifically include bodies and parts of motorcars such as automobiles, trucks, motorcycles, or buses.

The metal shaped article may have been subjected to chemical conversion treatment in advance with a phosphate salt, a zirconium salt, a chromate salt, or the like, and subsequent formation of an electrodeposition coating film as an undercoating layer. Examples of the electrodeposition coating composition which can be used for the formation of an electrodeposition coating film include a cationic electrodeposition coating composition and an anionic electrodeposition coating composition.

Examples of the plastic molded article include plates and molded articles of polypropylene resin, polycarbonate resin, urethane resin, polyester resin, polystyrene resin, ABS resin, vinyl chloride resin, polyamide resin, and the like. Examples of the plastic shaped articles include automobile parts such as spoilers, bumpers, mirror covers, grills, or doorknobs. These plastic shaped articles may have been provided with primer coating for enabling electrostatic coating as an undercoating layer.

The first base coating composition and the second base coating composition can be applied to an article to be coated by techniques commonly used in the coating material field. Examples of an application method include multistage application, preferably two-stage application, using air-spray application, airless-spray application, electrostatic spray application, or air-electrostatic spray application, or application combining air-electrostatic spray application and a rotary atomization type electrostatic applicator.

The heating temperature and time in the case of heating and curing the first base coating composition and the second base coating composition can be appropriately chosen according to the composition (aqueous or solvent-type) of the coating compositions and the type of the article to be coated. The heating temperature can be appropriately chosen, for example, in the range of 80 to 180° C., preferably in the range of 100 to 160° C. The heating time can be appropriately chosen, for example, in the range of 5 to 60 minutes, preferably 10 to 30 minutes.

The temperature at the time of preheating the first base coating film or the second base coating film may be, for example, 30 to 80° C., and the preheating time may be, for example, 1 to 60 minutes.

The first base coating composition is preferably applied such that the dry film thickness t₁ of the first base coating film after curing is within a range of 8 to 20 μm, and is more preferably applied such that the dry film thickness ti is 10 to 15 μm. In addition, the second base coating composition is preferably applied such that the dry film thickness t₂ of the second base coating film after curing is within a range of 8 to 20 μm, and is more preferably applied such that the dry film thickness t₂ is 10 to 15 μm.

The production method may further comprise, after the formation of the first base coating film and before the formation of the second base coating film, a first clear coating film forming step of applying a first clear coating material to the first base coating film to form a first clear coating film. Namely, an uncured first clear coating film may be formed by applying a clear coating material onto the uncured first base coating film in a wet-on-wet manner without heating and curing the uncured first clear coating film. In the heating and curing step, the uncured first base coating film and first clear coating film may be simultaneously heated and cured to form a multilayer coating film comprising the first base layer and the first clear layer. By forming the first clear coating film, irregularities or the like caused by the first base coating film can be smoothened, the first base coating film can be protected, and can be provided with an aesthetic appearance.

The production method may further comprise a second clear coating film forming step of, after the formation of the second base coating film and before the heating and curing, applying a second clear coating material to the second base coating film to form a second clear coating film. That is, an uncured second clear coating film may be formed by applying a clear coating material onto the uncured second base coating film in a wet-on-wet manner without heating and curing the uncured second clear coating film. In the heating and curing step, the uncured second base coating film and second clear coating film may be simultaneously heated and cured to form a multilayer coating film comprising the second base layer and the second clear layer. By forming the second clear coating film, irregularities or the like caused by the second base coating film can be smoothened, the second base coating film can be protected, and can be provided with an aesthetic appearance. The production method may comprise both the first clear coating film forming step and the second clear coating film forming step.

Example of the method for applying a clear coating material comprise an application method using a rotary atomizing electrostatic coating machine called micro micro bell or micro bell.

When the clear coating film forming step is adopted, the heating and curing temperature in the heating and curing step is preferably 80 to 180° C., and more preferably 120 to 160° C. from the viewpoint of curability and physical properties of the resulting multilayer coating film. The heating and curing time may be arbitrarily set according to the heating and curing temperature described above, and it is preferable that the heating and curing temperature is 80 to 160° C. and the heating and curing time is 10 to 30 minutes.

The multilayer coating film of the present disclosure exhibits a glitter texture, can achieve both a hiding property and chroma of the coating film, and therefore is preferably used for coating of automobile bodies and the like.

### EXAMPLES

The present disclosure will be described more specifically with reference to the following examples, but the present invention is not limited to the examples.

### Example 1

### (I) Preparation of Article to be Coated

A zinc phosphate-treated steel sheet with a cured electrodeposition coating film was prepared as an article to be coated. The cured electrodeposition coating film was formed by electrodeposition coating the zinc phosphate-treated steel sheet with “POWERNICS”, which is a cationic electrodeposition coating composition manufactured by Nippon Paint Co., Ltd., such that a dry film thickness was 20 μm, and then heating at 160° C. for 30 minutes.

### (II) Preparation of Coating Material

### (II-1) Preparation of Intermediate Coating Material

A 51.0 parts by mass of a thermosetting polyester resin (manufactured by Nippon Paint Co., Ltd., hydroxyl value: 80 mg KOH/g, acid value: 8 mg KOH/g, number average molecular weight: 1800, solid content: 70% by mass) and 49 parts by mass of a titanium dioxide pigment “CR-97” (manufactured by Ishihara Sangyo Kaisha, Ltd.) were added and uniformly dispersed, and 25.5 parts by mass of a melamine resin “U-VAN 128” (manufactured by Mitsui Cytec Ltd., solid content: 60% by mass) was further added and uniformly dispersed, affording a white intermediate coating material.

### (II-2) Preparation of Base Coating Composition

For the preparation of a base coating composition, an aqueous resin composition obtained by mixing the following (1) to (9) was used. Prepared was a base coating composition comprising:
(1) 236 parts of an acrylic emulsion resin (average particle size: 150 nm, nonvolatile content: 20%, solid acid value: 20 mg KOH/g, hydroxyl value: 40 mg KOH/g) produced by Nippon Paint Co., Ltd.,
(2) 10 parts by mass of a 10% by mass aqueous dimethylethanolamine solution,
(3) 28.3 parts by mass of water-soluble acrylic resin (nonvolatile content: 30%, solid acid value: 40 mg KOH/g, hydroxyl value: 50 mg KOH/g) produced by Nippon Paint Co., Ltd.,
(4) 8.6 parts by mass of “PRIMEPOL PX-1000” (bifunctional polyether polyol, number average molecular weight: 400, hydroxyl value: 278 mg KOH/g, primary/secondary hydroxyl value ratio=63/37, nonvolatile content: 100%) produced by Sanyo Chemical Industries, Ltd.,
(5) 21.5 parts by mass of “CYMEL 204” (mixed alkylated melamine resin, nonvolatile content: 100% by mass) produced by Mitsui Chemicals, Inc.,
(6) 26 parts by mass of “NeoRez R-9603” (polycarbonate-based urethane emulsion resin, nonvolatile content: 33% by mass) produced by Avecia,
(7) 0.2 parts by mass of lauryl acid phosphate,
(8) 10 parts by mass of 2-ethylhexanol, and
(9) 25 parts by mass of mono 2-ethylhexyl ether.

In the aqueous resin composition, the total of the solid mass of the coating film-forming resin and the solid mass of the curing agent (i.e., the solid content of the main resin) was 100 parts by mass.

By adding the pigments shown in Table 1 to the aqueous resin composition so as to attain the contents (PWC) shown in Table 1, a first base coating composition and a second base coating composition were obtained.

The mass concentration of the pigment was calculated from the following formula:

mass concentration (PWC) of pigment=(mass of pigment)/{(total mass of resin solid component of coating film-forming resin, resin solid component of curing agent, and solid component of additives)+(total mass of pigment)}×100 (%).

### (II-3) Preparation of Clear Coating Material

As a clear coating material, an acid epoxy curable clear coating material (trade name: MACFLOW O-1820 Clear, manufactured by Nippon Paint Automotive Coatings Co., Ltd.) was prepared.

### (III) Formation of Multilayer Coating Film

An intermediate coating material (diluted in advance to 25 seconds (measured at 20° C. using No. 4 Ford cup)) was applied to an article to be coated, by air-spray coating using an air spray gun W-101-132G manufactured by ANEST IWATA Corporation so as to have a dry film thickness of 35 μm. The coated plate was heated at 140° C. for 30 minutes with a dryer, affording a coated film article with an intermediate coating layer.

Subsequently, the first base coating material was air-spray applied under conditions of a room temperature of 23° C. and a humidity of 68% so as to have a dry film thickness of 15 μm. After setting for 3 minutes, preheating was performed at 80° C. for 4 minutes. The coated plate was allowed to cool to room temperature, and the clear coating material was air-spray applied so as to have a dry film thickness of 25 μm, followed by setting for 7 minutes. The coated plate was heated at 140° C. for 30 minutes with a dryer, affording a coated article with a first base layer.

Subsequently, the second base coating material was air-spray applied under conditions of a room temperature of 23° C. and a humidity of 68% so as to have a dry film thickness of 15 μm. After setting for 3 minutes, preheating was performed at 80° C. for 4 minutes. The coated plate was allowed to cool to room temperature, and a clear coating material was air-spray applied so as to have a dry film thickness of 35 μm, followed by setting for 7 minutes. Finally, the coated plate was heated at 140° C. for 30 minutes with a dryer, affording a coated article with a multilayer coating film.

### (IV) Evaluation

Coated articles were subjected to the evaluations described above. The results of the evaluations (1) to (6) are shown in Table 1.
(1) Lightness L*45

The lightness L*45 of the intermediate coating layer was acquired using a spectrophotometer (BYK-mac i manufactured by BYK Gardner).
(2) Chroma C*45

The chroma C*45 of the first base layer and that of the multilayer coating film were acquired using a spectrophotometer (BYK-mac i manufactured by BYK Gardner).
(3) Glitter Texture Si15 Value

The glitter texture Si15 value of the multilayer coating film was acquired using a spectrophotometer (BYK-mac i manufactured by BYK Gardner).
(4) Hue h15

The h15 was acquired using a spectrophotometer (BYK-mac i manufactured by BYK Gardner). Where the hue of the first base coating film was denoted as hl and the hue of the multilayer coating film was denoted as h2, the difference h1−h2 was calculated.
(5) Visible Light Transmittance

The light transmittance of each of the first base coating film and the second base coating film was measured in a section of 400 to 700 nm under conditions of a wavelength scan mode, a scan speed of 60 nm/min, and a sampling interval of 2 nm using a spectrophotometer (manufactured by Hitachi, Ltd., trade name: U-4100). The average light transmittance was obtained by averaging the light transmittance for every 10 nm.
(6) Hiding Property, Color Stability Against Variation in Film Thickness

A coated article having a multilayer coating film with a variation of +20% in the thickness of the base coating film was prepared, and compared with a coated article prepared with a normal film thickness, whether or not there was a feeling of incompatibility in color was visually evaluated.
good: incompatibility does not exist
not good: incompatibility exists

### Example 2, Comparative Examples 1 to 7>

Multilayer coating films were obtained and evaluated in the same manner as in Example 1 except that the pigment compositions in the first base coating material and the second base coating material were changed to those shown in Table 1.

TABLE 1

| | | | | | | | Com- | Com- | Com- | Com- | Com- |
|---|---|---|---|---|---|---|---|---|---|---|---|
| | | | | | Example | Example | parative | parative | parative | parative | parative |
| | | | | | 1 | 2 | Example 1 | Example 2 | Example 3 | Example 4 | Example 5 |
| Intermediate | Lightness | | L*45 | | 88.5 | 88.5 | 59.2 | 27.8 | 88.5 | 88.5 | 88.5 |
| coating | | | | | | | | | | | |
| First base | Visible light | | | | 9.10% | 12.90% | 9.70% | 9.70% | 9.70% | 9.70% | 30.10% |
| | transmittance | | | | | | | | | | |
| | Pigment | Coloring | Titanium | parts | 14.0 | | 16.6 | 16.6 | 16.6 | 15.5 | 5.9 |
| | composition | pigment | oxide | by mass | | | | | | | |
| | | | Bismuth | parts | 22.0 | 12.0 | 18.2 | 18.2 | 18.2 | 18.2 | 5.4 |
| | | | Yellow | by mass | | | | | | | |
| | | | Iron oxide | parts | 4.0 | | 3.1 | 3.1 | 3.1 | 3.1 | 1.0 |
| | | | Yellow | by mass | | | | | | | |
| | | | Iron oxide | parts | 0.5 | | 1.3 | 1.3 | 1.3 | 1.3 | 0.4 |
| | | | Red | by mass | | | | | | | |
| | | | Benz- | parts | 2.0 | | 1.9 | 1.9 | 1.9 | 1.9 | 0.6 |
| | | | imidazolone | by mass | | | | | | | |
| | | | Yellow | | | | | | | | |
| | | | Pyrrolopyrrole | parts | 0.2 | 1.0 | | | | | |
| | | | Red | by mass | | | | | | | |
| | Total PWC | | | % by | 42.7 | 13.0 | 41.1 | 41.1 | 41.1 | 41.1 | 13.3 |
| | | | | mass | | | | | | | |
| First clear | | | | | present | absent | present | present | present | present | present |
| | Visible light transmittance | | | | 87.2% | 83.8% | 87.2% | 87.2% | 57.9% | 99.5% | 87.2% |
| Second base | Pigment | Luster | Gold alumina | parts | 1.4 | | 1.4 | 1.4 | 1.4 | | 1.4 |
| | composition | pigment | flake | by mass | | | | | | | |
| | | | Gold mica | parts | | 1 | | | | | |
| | | | | by mass | | | | | | | |
| | | | Blue mica | parts | | | | | | | |
| | | | | by mass | | | | | | | |
| | | Coloring | Iron oxide | parts | 0.02 | | 0.02 | 0.02 | 0.02 | | 0.02 |
| | | pigment | Red | by mass | | | | | | | |
| | | | Perylene Red | parts | | 0.1 | | | | | |
| | | | | by mass | | | | | | | |
| | | | Cyanine Blue | parts | | | | | | | |
| | | | | by mass | | | | | | | |
| | | | Carbon black | parts | | | | | 0.05 | | |
| | | | | by mass | | | | | | | |

| Second clear | | | present | present | present | present | present | present | present |
|---|---|---|---|---|---|---|---|---|---|
| Hue | First base layer | h1 | 76.3 | 53.2 | 76.9 | 77.6 | 74.7 | 74.7 | 78.9 |
| | Multilayer coating film | h2 | 79.6 | 56.3 | 72.1 | 73.0 | 67.1 | 69.8 | 74.5 |
| | Hue difference | h1 · h2 | −3.3 | −2.8 | 4.8 | 4.6 | 7.6 | 4.9 | 4.4 |
| Chroma | First base layer | C45 | 65.5 | 70.8 | 62.5 | 61.9 | 65.0 | 65.0 | 70.0 |
| | Multilayer coating film | C45 | 62.8 | 70.8 | 56.8 | 56.1 | 48.9 | 54.5 | 64.3 |
| Glitter | Multilayer coating film | Si15 | 20.7 | 28.2 | 21.5 | 23.5 | 18.7 | 0.0 | 18.1 |
| texture | | | | | | | | | |

| | | | | | | | | |
|---|---|---|---|---|---|---|---|---|
| Hiding | Color stability when film thickness | good | good | not good | not good | not good | good | not good |
| property | | | | | | | | |

Examples 1 and 2 are examples of the present disclosure. In these examples, the products were confirmed to exhibit a glitter texture and could attain both the hiding property and the chroma of the coating films.

Comparative Examples 1 and 2 are examples in which the lightness at 45 degrees of the intermediate coating layers was less than 80. The color stability against variation in film thickness was insufficient, and the chroma was not sufficiently satisfactory.

Comparative Example 3 is an example in which the transmittance in the visible light region of the second base layer was less than 60%. The color stability against variation in film thickness was insufficient, and the chroma was not sufficiently satisfactory.

Comparative Example 4 is an example in which the second base layer comprised no luster pigment. The coating film did not exhibit a glitter texture.

Comparative Example 5 is an example in which the transmittance of visible light of the first base layer exceeded 30%, and the color stability at the time of film thickness variation was not sufficient and the chroma was not sufficiently satisfactory.

### INDUSTRIAL APPLICABILITY

The multilayer coating film of the present disclosure exhibits glitter texture, achieves both a hiding property and chroma of the coating film, and therefore is preferably used for coating of automobile bodies and the like.

What is claimed is:

1. A multilayer coating film comprising: an intermediate coating layer; a first base layer laminated on the intermediate coating layer; and a second base layer laminated on the first base layer,
wherein a lightness L* at 45 degrees of the intermediate coating layer is 80 or more,
wherein a visible light transmittance of the first base layer is 5 to 30%,
wherein a visible light transmittance of the second base layer is 60% or more, and
wherein the second base layer comprises a luster pigment.

2. The multilayer coating film according to claim 1, wherein an absolute value of a difference between a hue h1 of the first base layer and a hue h2 of the multilayer coating film is 20 or less.

3. The multilayer coating film according to claim 1, wherein a chroma C1 of the first base layer is 60 or more.

4. The multilayer coating film according to claim 1, wherein a chroma C2 of the multilayer coating film is 60 or more.

5. The multilayer coating film according to claim 1, wherein a glitter texture Si15 value of the multilayer coating film is 15 or more.

6. The multilayer coating film according to claim 1,
wherein the first base layer comprises a coloring pigment, and
wherein a content of the coloring pigment is 5 to 60 parts by mass in 100 parts by mass of a total solid content of the first base layer.

7. The multilayer coating film according to claim 1,
wherein the second base layer comprises a coloring pigment, and
wherein a content of the coloring pigment is 2 parts by mass or less in 100 parts by mass of a total solid content of the second base layer.

8. The multilayer coating film according to claim 1, wherein a content of a black pigment in the second base layer is 0 to 0.1 parts by mass in 100 parts by mass of a total solid content of the second base layer.

9. The multilayer coating film according to claim 1, wherein a content of a mica pigment in the second base layer is 0.1 to 15 parts by mass in 100 parts by mass of a total solid content of the second base layer.

10. The multilayer coating film according to claim 1, further comprising a first clear layer between the first base layer and the second base layer.

11. The multilayer coating film according to claim 10, further comprising a second clear layer laminated on the second base layer.
